(19) United States
(12) Patent Application Publication
(10) Pub. No.: US 2016/0259300 A1
(43) Pub. Date: Sep. 8, 2016

(54) Micro Push-Button Assembly

(71) Applicant: Penn Engineering & Manufacturing Corp., Danboro, PA (US)

(72) Inventor: Brian Bentrim, Furlong, PA (US)

(21) Appl. No.: 15/060,040

(22) Filed: Mar. 3, 2016

Related U.S. Application Data
(60) Provisional application No. 62/127,511, filed on Mar. 3, 2015.

(51) Int. Cl. G04B 37/00; G05G 1/02; G05G 25/04; G04B 27/08

(52) U.S. Cl. CPC G04B 37/00; G04B 27/08; G05G 1/025; G05G 25/04

(57) ABSTRACT

A micro push-button assembly includes a pin which has a head, a shoulder, a neck and a chamfer at the distal end. Other elements include a spring, a washer, and a seal. This unitized push-button assembly has two opposing ends each with distinct functionalities. One end of the assembly includes means extending above the head for press-in captivation with an exterior button while the other end has means for press in captivation with a support member such as a wrist watch chassis. The assembly is provided to the watch manufacturer as a pre-assembled unit with the spring and seal already set onto the operating pin. The final press-fit assembly can be accomplished by hand.

### RELATED APPLICATIONS

This is a non-provisional patent application which is related to provisional patent application Ser. No. 62/127,511 entitled, “Micro Push-Button Assembly” filed Mar. 3, 2015 priority from which is hereby claimed.

### FIELD OF THE INVENTION

The invention relates to a push-button assembly used in personal electronic devices such as wrist watches. More particularly, the invention relates to an assembly that connects a push-button to the chassis of the electronic device for actuating electrical switches or controlling other components within the electronic device.

### BACKGROUND OF THE INVENTION

Very small push-buttons are used on wrist watches to control time setting and other functions of the watch. Currently, electronic watch manufacturers use a series of loose components assembled during the construction of the watch to secure the button to the watch chassis. The button assembly must seal the inside of the device and allow for actuation of an interior button through a more ergonomic exterior button. The loose components of prior art button assemblies include a grooved pin, a C-clip, a spring, a seal and a washer. The C-clip, which affixes the button assembly to the watch chassis, must be installed by hand from the side of the pin inside the watch in a very tight space. Performing this assembly task is difficult and time-consuming Therefore it would be desirable to provide a pre-assembled push-button assembly, which can be easily affixed to the watch and which voids the need to hand assemble many loose components.

### SUMMARY OF THE INVENTION

The push-button assembly in accordance with preferred embodiments of the invention is provided to the manufacturer as a pre-assembled unit with a spring and seal already assembled on an operating pin. The pin assembly includes a pin having a head, a shoulder, a neck and a chamfer at the distal end. The pin assembly also includes a spring, a washer, and a seal. This unitized pin assembly has two opposing ends each with distinct functionalities. One end of the pin includes means extending above the head for press-in captivation with an exterior button while the other end has means for press-in captivation with a watch chassis. Because the elements of the assembly can be fitted together in one direction, machine assembly rather than hand assembly is possible. Furthermore, this unitized, pre-assembly of parts makes the final assembly at the manufacturing site relatively easier, quicker and cheaper than the prior art.

In preferred embodiments, the operating pin comprises, in order from top to bottom beginning immediately below a head, a shoulder, a shank having a narrowed neck portion, and a flange with a chamfer at a bottom distal end of the shank. A coil spring surrounds the shank neck portion and is operative between the flange above it and a seal below it, which captivates the spring to the pin. The pin reciprocates within a central bore of the seal, which has means on its exterior for attaching the pin to a support member. The seal is preferably elastomeric and has an exterior undercut. A washer may be interposed between the head of the pin and the seal. Button attachment means extends upwardly from the top of the head of the pin and is knurled so that it attaches the pin to a button receiving hole by simple manual press-fit. A support member such as a wrist watch chassis includes a receiving hole with a collar that engages the seal undercut to attach the push-button assembly to the watch chassis also by manual press fit. In one preferred embodiment, the button has a pair of laterally disposed guide fingers that engage and translate within apertures in the support member.

In another preferred embodiment, the pin assembly further includes a button pre-assembled to the pin of the assembly described above. In this embodiment, the assembly can also be attached to the watch chassis by a simple manual press fit.

The invention has many differences from the push-button devices of the prior art. Other differences and advantages will follow from the foregoing explanation and the following drawings and description of the invention.

### BRIEF DESCRIPTION OF THE DRAWINGS

FIG. 1 is an assembly view of a push-button assembly in accordance with preferred embodiment with the components shown in cross-section along with a watch button and chassis;

FIG. 2 is a side elevation of an assembled push-button assembly of FIG. 1; and,

FIGS. 3a and 3b are cross-sectional, assembled views of a push-button assembly connecting a watch button to a watch chassis showing the button in extended and depressed positions, respectively, in accordance with an embodiment of the invention.

### DESCRIPTION OF THE PREFERRED EMBODIMENT

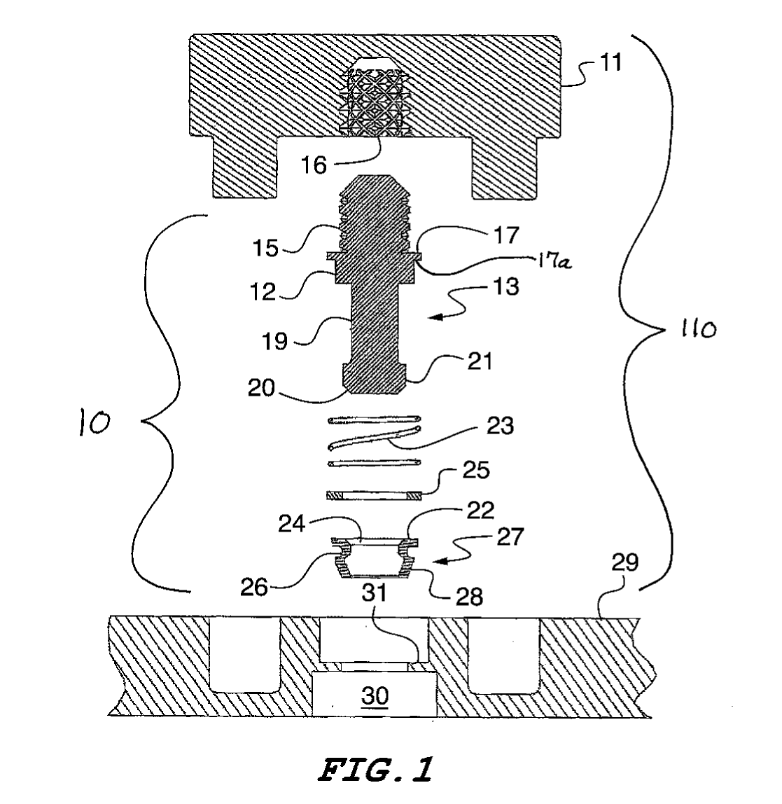

A push-button assembly in accordance with a preferred embodiment of the invention is shown in FIGS. 1-3 and is designated generally by reference numeral 10. Referring to FIG. 1, the push-button assembly 10 generally comprises an operating pin 13, a spring 23, a washer 25, and a seal 27. In a preferred embodiment, the push-button assembly 10 is used, and described hereinafter, to connect a push button 11 to the chassis 29 of a watch.

Referring to FIG. 1, the operating pin 13 has an upper knurled portion 15 and a head 17, which are constructed and arranged to connect with a bore 16 in a watch button 11. Preferably, the pin 13 is affixed to the button 11 by force fitting the knurled portion into an interior, textured receiving hole 16 in the button 11. In other embodiments, the pin 13 could be affixed using other known fastening techniques including adhesives.

Proceeding axially from the head 17, the pin 13 also includes a shoulder 12 having a diameter smaller than the diameter of the head 17, a shank neck 19 having a diameter smaller than the shoulder 12, and a flange 21 having a diameter intermediate the diameters of the shoulder 12 and neck portion 19. Preferably, the flange 21 has a chamfer 20 at the bottom most distal end. Preferably, the head 17 has the largest diameter on the pin 13 and includes a bottom surface 17a that contacts one end of the compression spring 23.

The shoulder 12 preferably has a diameter slightly smaller than the inner diameter of the coil spring so that the coil spring 23 is centered on the pin when the spring 23 is mounted on and envelopes (wraps around) the shoulder 12. The shank neck 19 is bounded above by the shoulder 12 and below by the flange 21.

The compression spring 23 is mounted over the shank neck 19 and shoulder 12 of the pin 13. One end of the compression spring 23 abuts the bottom surface 17a of the head 17 and the other end of the spring 23 abuts a flat washer 25, which has an outer diameter greater than the diameter of the spring 23. The inner diameter of the washer is greater than the diameter of the flange 21 so that the washer 25 can be installed over the shank neck 19. The washer 25 provides a stop at the bottom end of the spring 23. Thus, the spring 23 is captivated between the head 17 and the washer 25.

A seal 27 is installed over the flange 21. In this preferred embodiment, the seal 27 has a flat head 22, an axial bore with a beveled mouth 24, an undercut 26 and a tapered, frustoconical end 28. Preferably, the seal 27 is composed of elastomeric material. The bore has an interior size and shape that compliments the exterior size and shape of the flange 21 so that the seal can be installed over and fit snugly on the flange 21. The head 22 of the seal supports the washer 25 from below. The washer 25 can be a separate component as shown or could be incorporated into the seal 27 as a single piece. The chamfer 20 allows the seal to be easily installed on the flange in the assembly process described below.

In this embodiment, the push-button assembly 10 is assembled by first placing the spring 23 over the neck portion 19, around the shoulder 12, and up against the bottom surface 17a of the pin head 17. The washer 25 is then placed against the free end of the spring 23. Lastly, the seal 27 is installed over the flange 21 with the head abutting the underside of the washer 25 to prevent the washer from being pushed back off. The chamfer 20 on the end of the pin and an internal bevel around the mouth 24 of the seal 27 allow the seal to easily stretch over the flange 21. In preferred embodiments, the seal 27 is made of rubber or a similar material with good lubricity and elasticity. The central bore of the seal 27 mates resiliently with the neck 19 of the pin to provide a snug fit.

In another preferred embodiment of the invention, the push-button assembly 110 includes a button 11 that is pre-assembled to the top of the pin 13 but otherwise has the same construction as the assembly 10 described above. In this embodiment, the push-button assembly 110 is assembled by first attaching the button 11 to the top of the pin 13. The pin head 17 provides a positive stop that seats the pin 13 against the bottom face of the button 11. The pin13 is preferably press fit into the button 11. The remainder of the assembly 110 is then assembled in the same manner as the assembly 10 described above.

The seal 27 also functions to attach the assembly to a watch chassis 29. To achieve this function, the seal 27 has the flat head 22, the beveled mouth 24, the undercut 26, and the tapered, frustoconical end 28. In a preferred embodiment, the watch chassis 29 has a hole 30 into which the push-bottom assembly 10 or 110 connects. The hole 30 includes an inner, relatively-thin collar 31, which reduces the diameter of the hole 30 in that region. The push-button assembly 10 or 110 is connected to the chassis by simply pressing the assembly into the chassis hole 30. By doing so, the seal 27 is compressed into the collar 31 and pressed down to a point where the seal undercut 26 snaps around the collar 31. This structure resiliently clinches the assembly 10 or 110 to the watch chassis 29. The flat shape of the seal around the bottom of the undercut prevents the assembly from easily pulling back over the collar 31 and out of the chassis 29.

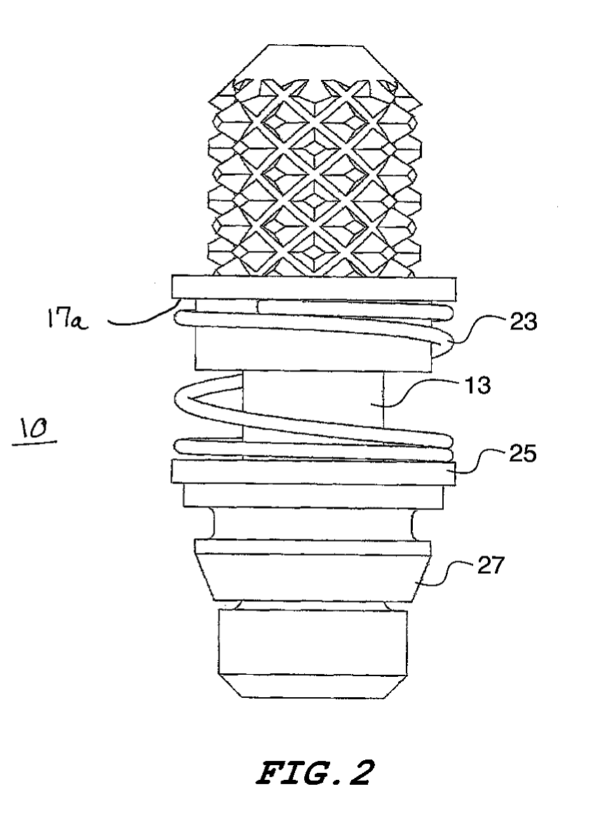

A fully-assembled push-button assembly 10 is shown in FIG. 2 in isolation without a button llor watch chassis 29 affixed thereto. The push-button assembly 10, and likewise push-button assembly 110, consists of unitized, joined components, which can be handled separately without additional components and which can be utilized as a universal sub-component that can be applied to numerous different button and support structure combinations.

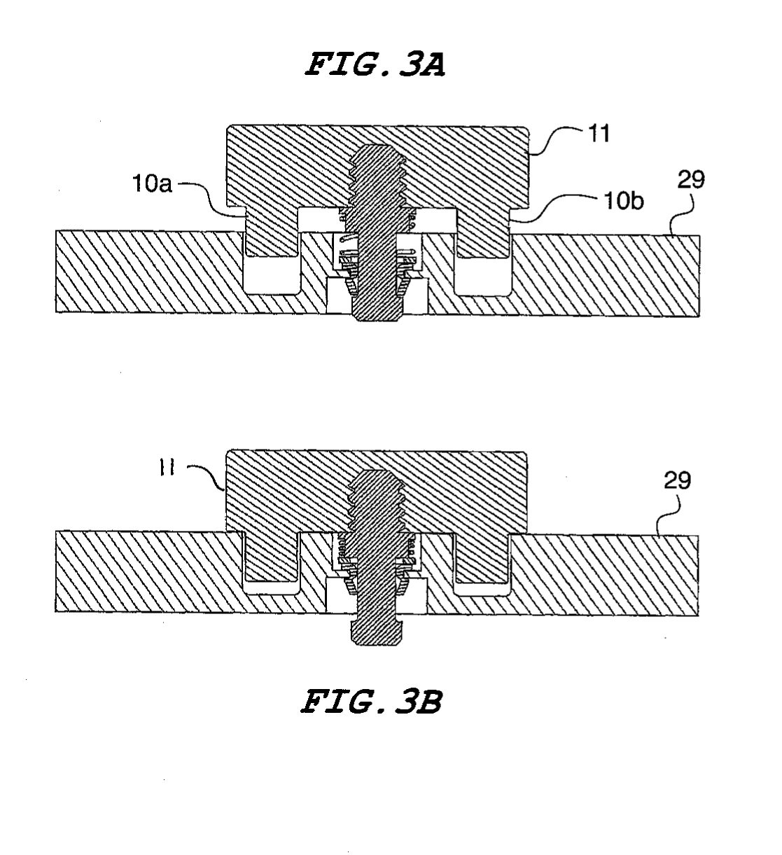

The components of FIG. 1 are shown fully assembled in FIGS. 3a and 3b. The push-button assembly 10 or 110 is shown in operation when attached to a watch chassis 29 as it is pushed and released. It will be appreciated by those of skill in the art that the various dimensions of the components are selected so that the action of the button 11 is compatible with the features of the watch chassis. For example, the bottom face of the button 11 should contact the chassis 29 when or just before the pin reaches its maximum point of extension. In this embodiment, a button 11 is shown having guide fingers 10a and 10b that are laterally disposed on opposite sides of the operating pin. The guide fingers 10a, 10b slideably engage corresponding apertures in the chassis and provide lateral and torsional support to the button 11 during its movement.

The embodiments of the invention described above provide a simplified, ergonomic button assembly that can be easily applied to a space-constricted chassis. Preferred embodiments of the invention are particularly suited for electronic watches.

The foregoing description of preferred embodiments is to be considered illustrative only of the principles and possible embodiments of the invention. Further, since numerous modifications and changes will readily occur to those skilled in the art, it is not desired to limit the invention to the exact construction and operation shown and described. Accordingly, suitable modifications and equivalents may be resorted to, all falling within the scope of the invention which shall be determined only by the following claims and their legal equivalents.

1. A push-button assembly, comprising:
an operating pin having in order from top to bottom beginning with a head, a shoulder, a shank having a narrowed neck portion, and a flange at a bottom distal end of the shank; and
a coil spring surrounding the shank neck portion operative between the flange above and a seal below which captivates the spring to the pin, said pin being reciprocal within a central bore of the seal which has means for attaching the seal to a support member.

2. The assembly of claim 1 wherein said seal is elastomeric.

3. The assembly of claim 1 further including a washer surrounding the pin interposed between the spring and the seal.

4. The assembly of claim 1 wherein the support member is a chassis of a wrist watch.

5. The assembly of claim 1 further including a button affixed to the top of the head of the pin.

6. The assembly of claim 5 further including attachment means on the pin extending upwardly from a top of the pin head for affixing the button to the pin.

7. The assembly of claim 6 wherein the attachment means is a knurled portion of the pin whereby the button can be attached to the pin by a simple press fit of the knurled portion into a receiving aperture in the button.

8. The assembly of claim 2 wherein the seal is elastomeric and has features which allow press-in attachment of the assembly to the support member.

9. The assembly of claim 8 wherein the support structure has a hole with a collar that receives the assembly and the seal has an exterior undercut that engages the collar.

10. The assembly of claim 9 wherein the support member is a chassis of a wrist watch.

11. The assembly of claim 8 further having a chamfer at the bottom of the shank.

12. The assembly of claim 5 wherein said button includes guide fingers which slideingly engage corresponding apertures in the support member to provide torsional support to the button.

13. The assembly of claim 12 wherein the support member is a chassis of a wrist watch.

14. The assembly of claim 13 wherein the guide fingers are laterally disposed on opposite side of the operating pin.

15. The device of claim 1 which is a unitized assembly of parts without additional components.
